(19) United States
(12) Patent Application Publication
(10) Pub. No.: US 2011/0056198 A1
(43) Pub. Date: Mar. 10, 2011

(54) Compressed Air Steam Hybrid

(76) Inventors: Samuel Jackson Flakus, Carson City, NV (US); Joshua Wayne Carlson, Carson City, NV (US)

(21) Appl. No.: 12/509,494

(22) Filed: Sep. 8, 2009

(51) Int. Cl. F02B 33/34; F01N 13/10

(52) U.S. Cl. 60/598; 60/323

(57) ABSTRACT

A method and apparatus for the capture of wasted heat energy from an internal combustion engine for conversion of water from a liquid state into a gaseous state, the resulting pressure of which being used to drive a steam-driven air compressor, before being directed to a radiator-type condenser for conversion of water from a gaseous state back into a liquid state for reuse. The compressed air from the said steam-driven air compressor is directed to the cylinder head(s) upon the engine the heat is derived from, via an automatic regulator, where air is directed into multiple cylinders of the said internal combustion engine to assist in the propulsion of the pistons within the said cylinders and to assist in the efficiency of ignition of fuel molecules, both attributes of which are in the interest of greater efficiency in fuel consumption of the vehicle the apparatus is situated in.

### DESCRIPTION OF THE PREFERRED EMBODIMENT

The invention as described in this United States patent application is that of an innovative idea to use the otherwise wasted heat energy of from an internal combustion engine to assist in the work that some of the fuel would otherwise be required to perform, but is not the first. Similar ‘Steam Hybrid’ devices, which were in many cases derived from a process used in some natural gas power plants known as a “Combined Cycle” system, propose the use of external generators, motors, gears and transmissions, etc., for the efficient utilization of this often overlooked energy source in elaborate and complex schematics in order to rescue mere drops of fuel. Other designs using the cylinders of the engine itself have a habit of sending atomized water into those cylinders along with the fuel and air mixture, but one can assume that water is not a good thing to have in an environment that is normally supposed to be as dry as possible, let alone the resulting condensation within those cylinders.

The victor over the fierce competition for providing just one, of many, mechanical answers for combating climate change and environmental destruction without humanitarian consequences must be mindful of what the ultimate, most ideal invention using the principles of Combined Cycle technology within a vehicle of any practical shape or size would look like. Those ideals, composed of simplicity, durability, ease of manufacture, efficiency, versatility and the use of few moving or non-moving parts performing a multitude of tasks, provide for a nearly perfected machine (for no machine is perfect) that utilizes a new and bold method for hybrid technology unto itself.

While the device is essentially a form of steam engine, in practice, a Compressed Air Steam Hybrid apparatus cut in half seems to resemble a gas turbine on a jet aircraft. It is, after all, intended to be operational on all types of internal combustion engines, whether of the reciprocating or rotary type, although implementation within a gas turbine will obviously take on an alternate appearance. Atomized water or glycol, being sent through hot flues heated by the exhaust gases from the engine upon which the device is affixed to, expands as it travels through the flues and is ejected straight into the blades of the steam turbine, before the steam is sent to the vehicle's existing radiator, which serves as a condenser. The device sits upon the exhaust ports of the internal combustion engine, a space that would normally be occupied by a normal exhaust manifold. This piece of cast iron is notorious for getting hot enough to burn off any oil drippings or paint within minutes.

The device as described within this application officially captures only the heat of the exhaust of an engine, but that does not mean that it cannot utilize the heat of its coolant or lubricants. The reason for this is that the ideally versatile and thus marketable device should not infringe too greatly upon the design of the vehicle according to its operator, designer and/or owner. Therefore, they have the option of feeding the water into the atomizer by means of a water pump, injector or a heat exchanger that forces steam or hot water in. The designer further has the option of converting the engine block itself into a boiler, using the Compressed Air Steam Hybrid apparatus as a super heater, but this is dependant upon the strength of the engine block and how much steam it can supply for both heat and water to be used in the most efficient manner.

Of further benefit on account of this invention over previous attempts at creating a ‘Steam Hybrid’ is the relay of tractive effort from the steam turbine to the wheels in cooperation with the main engine being performed by means of compressed air. Through this method, a separate steam engine mechanically bound to the crankshaft, nor an elaborate electric transmission, are required. Rather, the compressed air is forced into each of the cylinders or combustion chambers of the engine itself via a regulator, which also directs air to a reservoir for storage. The air, after having its pressure regulated according to Revolutions per Minute and throttle position, flows through valves that open during their power strokes or sequences by means of the engine's cam shaft(s). When accelerating, there is a lack of adequate air pressure to assist in propelling the vehicle, so the regulator must admit air from the air reservoir until the air from the steam-driven air compressor can supply enough pressure. When the engine decelerates, the engine is still hot even though there is less fuel/oxygen mixture within the cylinders. This means that the air compressor will continue to supply compressed air even when it is not needed, therefore, it is directed into the air reservoir to be used for the next time the engine accelerates. The regulator also balances the ratio of compressed air to fuel/oxygen mixture by giving the compressed air priority over the fuel/oxygen mixture once full pressure within the air reservoir has been obtained.

The intent of compressed air being pumped into the cylinders of an engine using otherwise wasted heat energy is to not only help the ignited expanding gases push down on the pistons, but to provide more necessary oxygen to the atomized mixture in order to allow more if not all of the fuel molecules to ignite after the combustion stroke has commenced. In conventional engines, these unignited molecules go to waste, because only so much air can be compressed with a fuel mixture before it explodes. For this reason, there is not enough oxygen to reach all of the fuel molecules by the time the piston has reached the bottom of the stroke and the exhaust valve is opened. The remaining perfectly good fuel molecules would otherwise be ejected out into the atmosphere with the aggregate gases as a major contributor to smog. With compressed air being added during the power stroke of the sequence, all of the fuel molecules are given adequate oxygen molecules to match so that all may ignite and further reduce the amount of fuel needed to obtain an equivalent number of Revolutions per Minute.

### BACKGROUND OF THE INVENTION

Humanity and the environment it resides in are immediate victims of the exponential growth of the demand for fossil fuels and inevitable pollution that parallels it as a result. Essential to the requirements of a modern sophisticated society are that of the discovery of bold yet practical innovations that allow for the continuation of planetary existence without the compromise of human progression. Necessary to the survival of the welfare of the Good Earth and the equal opportunity within the economic sanctity of the human existence that dwells upon it is the security of alternatives to the wasteful lifestyle that arises from the dependence upon fossil fuels. The seemingly bottomless pits from which the incredibly energy-nutrient black sludge originate prompt the rise of corporations with and without good will, both of whom profit gluttonously from the conversion of oxygen and liquids into motion and toxic gases that choke the atmosphere.

The resulting low cost of transportation has led, in the last half-century, to vast sprawling expansion across the landscape like waves from a rock being thrown into a pond. The towers of Downtown have fallen, and in their place are paved the parking lots and super blocks of monotonous commercial retail buildings, providing for the further psychological dependence upon consumption. However, it would be equally foolish to seek alternatives to a fuel as versatile and useful as oil when it can simply be used wisely and more efficiently in a manner that allows for the use of energy within that which would otherwise go to waste. Companies and innovators from far and abroad have contributed to the development of what is now known as a Hybrid; a method of propulsion that utilizes an internal combustion engine providing traction to the wheels by means of an electrical transmission. Part of the use of this device is the implementation of dynamic braking, a principle that uses the motor that drives the wheels as a generator to develop electricity with the momentum of the vehicle for storage within batteries. The system is backed by an elaborate computer system to control the inner workings. With due consideration to the extensive increase in cost to an already expensive vehicle, however, the amount of energy saved for reuse is a drop in the bucket in comparison to what can be saved in the form of what has been lost through heat.

As described within this patent application, this invention pertains to the capture of heat energy emitted by internal combustion engines in order to assist in the propulsion of the said engine, and therefore its vehicle and appliances within. In saving the heat from the combustion of liquid fuel, one is able to utilize an entire source of energy that would otherwise go to waste. It is a further asset to the stated invention that the device can be implemented as an appliance onto any existing reciprocating engine within marine vessels, aircraft, locomotives, small auxiliary power plants, and automobiles of all scales.

### BRIEF DESCRIPTION OF THE DRAWINGS

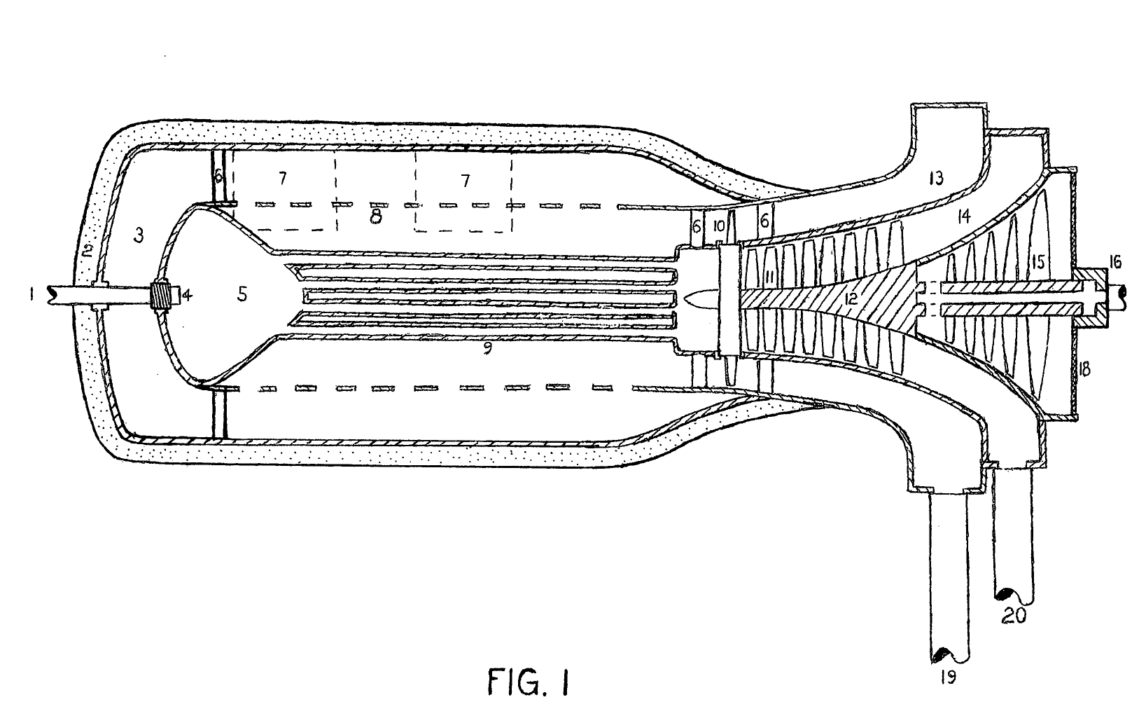

FIG. 1:
1. Water Inlet
2. Insulation
3. Insulated Manifold
4. Atomizer
5. Expansion Chamber
6. Braces
7. Hot Exhaust Inlet Ports
8. Muffler Grate
9. Flues
10. Primer Blades
11. Steam Turbine Blades
12. Main Shaft
13. Gaseous Exhaust Chamber
14. Steam Exhaust Chamber
15. Compressor Turbine Blades
16. Air Tight Bearing
17. Compressed Air Outlet
18. Air Filter
19. Gaseous Exhaust Outlet
20. Steam Exhaust Outlet

What is claimed is:

1. A method and apparatus for the capture of hot gases exhausted from an internal combustion engine within an insulated manifold for the purpose of heating separately encapsulated atomized water into steam, the said steam propelling a steam turbine providing rotary mechanical motion to an air compressor turbine, the resulting compressed air being directed to the combustion chamber(s) of the said internal combustion engine upon which the Compressed Air Steam Hybrid apparatus is mounted.

2. The insulated manifold as recited in claim 1 being comprised of a conduit insulated throughout its outer circumferential surfaces with a heat resistant material or vacuum and encapsulating a muffler grate, an atomizer, an expansion chamber and a plurality of flues.

3. The insulated manifold as recited in claim 2 being further comprised of a plurality of exhaust ports for entry of hot exhaust gases from the internal combustion engine as recited in claim 1 into the said manifold.

4. The muffler grate as recited in claim 2 being comprised of a conduit having a plurality of holes within its surface area providing an outlet for hot exhaust gases from the insulated manifold as recited in claim 2, the hot exhaust gases being directed onto the surfaces of the flues as recited in claim 2.

5. The muffler grate as recited in claim 4 having, further utilization as a muffler for the reduction of exhaust noise from the said internal combustion engine as referred to in claim 1.

6. The atomizer as recited in claim 2 being comprised of a steam-tight fitting receiving and distributing water and/or steam in the form of a mist within the expansion chamber as recited in claim 2.

7. The expansion chamber as recited in claim 2 being comprised of an aerodynamic steam tight vessel distributing vaporized water from the atomizer as referred to in claim 6 into the plurality of flues as referred to in claim 2.

8. The plurality of flues as recited in claim 7 being comprised of a multitude of steam tight tubes, all of which having hot exhaust gases from the internal combustion engine as referred to in claim 1 circulating in contact with the outer surfaces of the said flues, and carrying steam within from the affixed expansion chamber as referred to in claim 7.

9. The steam turbine as recited in claim 1 being comprised of a plurality of rows of turbine blades upon a centrally revolving shaft upon which the energy of the pressurized steam from the flues is converted into mechanical rotational energy.

10. The steam turbine as referred to in claim 9 being further comprised of a row or series of rows of turbine blades attached to and revolving around the outer circumference of the steam turbine blades via a steam tight bearing and being driven by the hot exhaust gases for further rotation of the said steam turbine during periods of low steam pressure.

11. The air compressor turbine as recited in claim 1 being comprised of a plurality of rows of turbine blades upon a centrally revolving shaft, the said centrally revolving shaft developing mechanical rotary motion and energy from the steam turbine as recited in claim 9.

12. The air compressor turbine as recited in claim 10 further providing for the purpose of directing the resulting compressed air to the combustion chamber(s) of the internal combustion engine upon which the Compressed Air Steam Hybrid apparatus is mounted and all appliances operated by the said resulting compressed air via a regulator.
